(19) United States
(12) Patent Application Publication
(10) Pub. No.: US 2015/0330366 A1
(43) Pub. Date: Nov. 19, 2015

(54) Medium/Large Electricity Generator Equipped with Automatically Winding and Un-winding Kite Cable Mechanism for minimum energy loss

(71) Applicants: Young Suk WOO, Los Angeles, CA (US); Chang Deuk Woo, Los Angeles, CA (US)

(72) Inventors: Young Suk WOO, Los Angeles, CA (US); Chang Deuk Woo, Los Angeles, CA (US)

(21) Appl. No.: 14/280,594

(22) Filed: May 17, 2014

(51) Int. Cl. F03D 9/00; F03D 5/00

(52) U.S. Cl. CPC F03D 9/002; F03D 5/00; F05B 2240/922

(57) ABSTRACT

A medium/large electricity generator equipped with automatically winding and un-winding kite cable mechanism for minimum energy loss is provided. The electricity generation system of the current invention comprises of pluralities of medium size electricity generators, multiplying gears, ampere transfers, cable shafts, automatic clutches, automatic breaks, and auto gear transformers mounted on one medium generator supporting frame, which is mounted on one large power generator system that rotates 360 degrees freely in counter clockwise and counter clockwise. The large power generator system is mounted on a round supporting frame firmly installed on a ground. Each kite is connected to two neighboring cable shafts via one kite cable on one cable shaft. The electricity generator uses negligible energy to wind the kite compared to all other prior arts that use kite for power generation.

### 1. FIELD OF THE INVENTION

The present invention refers to an electricity generating system by converting wind energy to electricity by kites dragged by wind. The present invention further refers to a mechanism for producing electric energy through such system with minimum energy loss.

### 2. BACKGROUND OF THE INVENTION

Wind is one of the clean renewable energy sources that has been used along with the history of mankind, windmill. From 20^{th} Century, windmill type electricity generators are being used commercially throughout many countries. The windmill type electricity generators are expensive and need huge blades and large isolated ground surface area for maximum power generation and safety. And it is very dangerous to fix problems on the turbine and blades. Recently, another type of electricity generators using wind energy is developed. They use big kites that reach high altitude. Typical electricity generator, usually small size, is attached to the kite cable and is flying in the sky by the drag force of the huge kite. These kite flown electricity generators have critical limitation of the size of the generator that can be attached to the kite cable due to the weight of the generator itself. And it is very dangerous when one of the kite cables is broken by strong wind or when the wind speed is not fast enough to hold the weight of the generator. Then the heavy generator, attached on the kite cable, will fall to the ground from very high altitude. It is very dangerous situation if there is some housing or animal/human passes by. To avoid such dangerous situation some new kite driven electricity generators are introduced. In that new kite driven electricity generator the main electricity generator is placed on ground solidly. Therefore the size of the generator has no limit if the land is secured. But, these new kite driven electricity generator, which has generator placed on the ground solidly, has problem in terms of energy efficiency because the kite once deployed has to be re-winded at some time and the electricity produced by the generator is used to re-wind the kite cables that reaches hundred meters long and still has drag force by the wind that hold the kite. It is purpose of the current invention to provide a kite driven electricity generator, which has generator body on the ground and has more energy efficiency.

### DESCRIPTION OF PRIOR ARTS

In particular, U.S. Pat. No. 4,124,182 discloses a device equipped with “parakites” (or “modified parachutes”) to capture wind energy and convert it into the rotary motion of a shaft that actuates a generator. This device is characterized by a pair of “trains of parakites” in which the kites are arranged in series. Each train is equipped with a power rope. Such cables are long enough to allow the trains of parakites to reach heights at which stronger and more uniform winds blow with respect to those that blow at earth surface level. Every train is constrained through the corresponding power rope to a drum or a winch whose rotation direction can be alternated so that it winds again the ropes or allows unwinding the ropes due to the wind current traction. Every train of parakites is equipped with a second rope, called “cap-type”, connected to each train kite and through which it is possible to selectively collapse the parakites to facilitate the rewinding procedure. Through a reducer, the rotary motion of each winch is transferred to a generator that, when actuated, produces electricity. There is a single system of pulleys that, through clutches and gears, makes a train of parakites recovered while the other one ascends. The captured wind energy is therefore converted into mechanical energy that in part is immediately spent for recovering the train of parakites whose cap has been closed, and in part is converted into electric energy. Through an aerostatic balloon constraint to each train and inflated and deflated upon every operating cycle, the parakite are kept at a desired height and the caps have a fixed orientation.

WO 2007122650 discloses a device equipped with a plurality of kites that, due to the wind action effect, rotate a vertical shaft connected to a generator for producing current. The kites are pushed by the wind performing a circular path in the horizontal plane. Every kite is equipped with a device able to modify the wind attack angle in order to guarantee flight continuity.

U.S. Pat. No. 6,072,245 discloses a device for exploiting wind energy composed of a multitude of kites connected to ropes forming a ring. The kites are driven in order to alternate an ascending path to a descending one, determining a rotary motion of the ring always along the same direction. Every kite is connected to a power for transmitting mechanical energy and to a system of driving ropes for adjusting the wind attack angle of each kite. The power rope determines the rotation of pulleys through which the electricity production occurs. The driving ropes are used for making each kite assume a position that, in the ascending path, allows the kite to be dragged upwards by the wind, and a second position in the descending path so that the kite is subjected to a lower wind thrust.

U.S. Pat. No. 6,254,034 discloses a device equipped with a kite (“tethered aircraft”) pushed by the wind currents at a controlled height, in order to exploit the wind energy. The kite is connected through a rope to a winch that actuates a generator for producing electric energy. On board the kite, a driving system is assembled, that detects and modifies the wind attack angle and modifies the intercepted wind front area. Such system is controlled from ground by an operator that reads on a display data transmitted by suitable sensors, or automatically through a remote control system. The kite is driven in order to downwind ascend with a high attack angle. After having ended the ascension, the attack angle is reduced and the kite glides in order to bring itself upwind. The kite is recovered, again glides downwind and the cycle is repeated.

EP 2682599 discloses a device similar to the previous above described one in which however the manual driving mode is not provided, and in which the kite recovery occurs by slanting the kite as a flag, in order to minimize the wind thrust when rewinding the ropes.

U.S. Pat. No. 6,523,781 discloses a device composed of a kite (“airfoil kite”) through which the wind energy is captured, having an inlet edge, an outlet edge and two side edges. Such kite is driven through a mechanism supported by the kite itself. This device is equipped with ropes connected to the kite edges and the kite is driven by modifying, through these ropes, the pitch angle. The driving mechanism is supplied by electric cables placed inside a power rope that connects the kite to a winch that actuates a generator for producing electricity. The kite ascends pushed by the wind exploiting the lift force and describing an almost perpendicular path to the wind speed direction. After having ended the ascension, the kite is recovered and afterwards driven in order to capture again the wind.

U.S. patent application US2005046197 discloses a device equipped with a kite for exploiting the wind energy that generates electricity by actuating, by means of ropes, a winch connected to a generator. The kite is driven by means of additional ropes through which the wind attack angle is modified. The kite ascends with a high attack angle. After having ended the ascension, the attack angle is minimized and the kite is recovered in order to start the cycle again.

U.S. Pat. No. 8,511,465 of the same Applicant of the present application discloses a wind system for converting energy comprising at least one kite that can be driven from the ground immersed in at least one wind current and a wind turbine with vertical axis placed at ground level, such wind turbine being equipped with at least one arm connected through two ropes to the kite, such kite being adapted to be driven by the turbine in order to rotate the arm and perform the conversion of wind energy into electric energy through at least one generator/motor system operating as generator cooperating with the turbine, the ropes being adapted both to transmit mechanical energy from and to the kites and to check the kite flight trajectory. In such wind system with arms and rotating shaft, the production of electric energy occurs by exploiting the twisting moment generated on the turbine arms by the kites and driving of the kites occurs only by means of ropes. Moreover, in such wind system with arms and rotating shaft, the components arranged for storing the ropes and driving the kites are in the turbine centre and therefore far away from the point in which the ropes go away from the ground towards the kites. Finally, in such wind system with arms and rotating shaft, the kite recovering pipes are fixed.

Anyway, as can be noted by analyzing the existing prior art, known wind systems equipped with kites have in general the following common characteristics: the kites are equipped both with power ropes and with driving ropes: this means that the rope load through which the electricity production occurs is not transmitted to the kite driving mechanisms, but to other wind system components, through ropes suitably employed for performing this function. The lack of use of power ropes for driving the kites makes the wind system structure complicate, with all related disadvantages;

the kites are driven by mechanisms directly installed on the kites or through auxiliary (driving) ropes. Unwinding and rewinding of these ropes occur by means of winches exclusively used for such purpose, placed at ground level or suspended from the ground (namely supported by the kites themselves). In case of use of driving ropes, placement of winches at ground level, allows not to consume part of the energy subtracted from the wind currents to support the driving mechanisms weight;

the kites are driven in order to generate electricity when ascending by exploiting the drag force (namely the wind thrust component parallel to the wind speed). Such step is followed by the recovery of kites by placing the kites as flags, in order to minimize the braking effect. In a limited number of wind systems, it has been devised to exploit the lift force (namely the wind thrust component perpendicular to the wind speed) in addition to the drag force in order to make the kites climb. The advantage deriving form the use of this latter driving mode with respect to the previous one consists in that, in order to produce electricity, not only the kite resistance but also the kite lift is exploited. Anyway, in both modes, the intermittence-type operating cycle (an ascending step alternated with a recovery step) implied that the dragging effect of the kites through which the production of electricity occurs, is present only during half of the path described by the kites (in fact, it is absent during the recovery);

the energy conversion occurs by imposing, through the power ropes, the rotation of winches connected to generators, possibly by interposing reducers. This does not allow producing energy with continuity during an operating cycle, since the kite recovery occurs by actuating such winches through motors. In such a way, an electricity generation interruption occurs and a consumption of the previously produced energy. The continuous current delivery to external users is made possible by using accumulators; attention has been focused exclusively on the production of electricity through a cyclic process. The choice of the path that the kites must describe when flying in order to maximize the rate of converted energy is almost completely neglected;

the problems related to the control system of a kite or of a train composed of many kites connected in series are dealt with in detail in an extremely reduced number of projects and researches. This is also due to the fact that current researches are mainly focused on the increase of productivity of already existing systems instead of on the development of new energy producing systems.

In order to partially solve the above problems, European Patent Application EP 1 672 214 in the name of Sequoia Automation S.r.l. instead discloses a system for converting kinetic energy of wind currents into electric energy through the predictive and adaptive check of the flight of kites connected to a “carousel”-type system using a vertical axis turbine.

Object of the present invention is solving the above prior art problems by providing a wind system for converting energy by translating on a rail modules dragged by kites that is different from the current state of the art in particular due to the modes with which the kites are driven, the path traveled by such kites when flying in order to maximize the rate of converted energy and the wind system architecture, in which each module is connected through at least one rope to a train of kites that, pushed by the wind and suitably driven, generates at module level, a traction due to which the module translated on at least one rail that performs a closed path and through a generating system cooperating with module and rail generates electric energy.

### SUMMARY OF THE INVENTION

From 20^{th} Century, windmill type electricity generators are being used commercially through out many countries. The windmill type electricity generators are expensive and need huge blades and large isolated ground surface area for maximum power generation and safety. And it is very dangerous to fix problems on the turbine and blades. Recently, another type of electricity generators using wind energy is developed. They use big kites that reach high altitude. Typical electricity generator, usually small size, is attached to the kite cable and is flying in the sky by the drag force of the huge kite. These kite flown electricity generators have critical limitation of the size of the generator that can be attached to the kite cable due to the weight of the generator itself. And it is very dangerous when one of the kite cables is failed by strong wind or when the wind speed is not fast enough to hold the weight of the generator. Then the heavy generator, attached on the kite cable, will fall to the ground from very high altitude. It is very dangerous situation if there is some housing or animal/human passes by. To avoid such dangerous situation some new kite driven electricity generators are introduced. In that new kite driven electricity generator the main electricity generator is placed on ground solidly. Therefore the size of the generator has no limit if the land is secured. But, these new electricity generator, which has generator placed on the ground solidly, has problem in terms of energy efficiency because the kite once deployed has to be re-winded at some time and the electricity produced by the generator is used to re-wind the kite cables that is hundred meters long and still has drag force by the wind that hold the kite. A medium/large electricity generator equipped with automatically winding and un-winding kite cable mechanism for minimum energy loss is provided. The electricity generation system of the current invention comprises of pluralities of medium size electricity generators, multiplying gears, ampere transfers, cable shafts, automatic clutches, automatic breaks, and auto gear transformers mounted on one medium generator supporting frame, which is mounted on one large power generator system that rotates 360 degrees freely in counter clockwise and counter clockwise. The large power generator system is mounted on a round supporting frame firmly installed on a ground. Each kite is connected to two neighboring cable shafts via one kite cable on one cable shaft. The electricity generator uses negligible energy to wind the kite compared to all other prior arts that use kite for power generation.

### BRIEF DESCRIPTION OF THE DRAWINGS

FIG. 1 is a side view of three dimensional power generating system of the current invention.

FIG. 2 is a plane view of a kite according to current invention.

FIG. 3 is a schematic sketch of a kites connected to the three dimensional power generating system of the current invention.

FIG. 4-a is a schematic sketch of the movement of the cable shaft seen from the point ‘A’ in the FIG. 3 when the left kite is deploying and the right kite is descending.

FIG. 4-b is a schematic sketch of the movement of the cable shaft seen from the point ‘A’ in the FIG. 3 when the right kite is deploying and the left kite is descending.

FIG. 5 is a schematic drawing of large power generator that uses multi kites on one pair of the cables and multi medium size power generators of the current invention.

### DETAILED DESCRIPTION OF THE PREFERRED EMBODIMENT

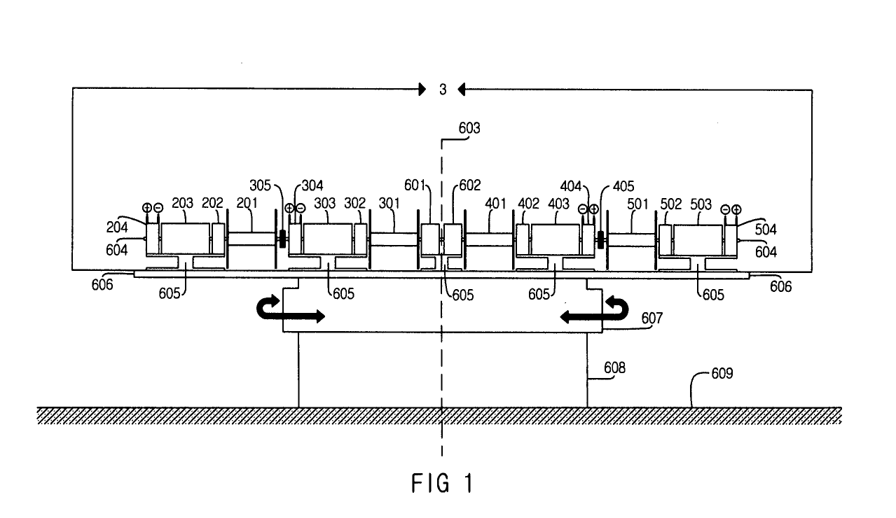

FIG. 1 is a side view of three dimensional power generating system (1) of the current invention. The three dimensional electricity generating system (1) comprises of four medium size electricity generators [first medium size electricity generators (203), second medium size electricity generators (303), third medium size electricity generators (403), and fourth medium size electricity generators (503)], four multiplying gears of 1:97 ratio [first multiplying gear (202), second multiplying gear (302), third multiplying gear (402), and fourth multiplying gear (502)], four ampere transfers [first ampere transfer (204), second ampere transfer (304), third ampere transfer (404) and fourth ampere transfer (504)], four cable shafts [first cable shaft (201), second cable shaft (301), third cable shaft (401), and fourth cable shaft (501)], two automatic clutches[first automatic clutch (305) and second automatic clutch (405)], one automatic break (601), and one auto gear transformer (602). Each of the four medium generators, each of the four multiplying gears, and each of the four ampere transfers are mounted on a supporting frame (605). One automatic break (601) and one auto gear transformer (602) are also mounted on a separate supporting frame (605). The first cable shaft (201) is located between the first multiplying gear (202) and the first automatic clutch (305). The second cable shaft (301) is located between the second multiplying gear (302) and the automatic break (601). The third cable shaft (401) is located between the auto gear transformer (602) and the third multiplying gear (402). The fourth cable shaft (501) is located between the second automatic clutch (405) and the fourth multiplying gear (502).

Total five supporting frames (605) are mounted on one medium generator supporting frame (606). All of the four medium size generators, multiplying gears, automatic break (601), and automatic gear transformer (602) are connected via one power generator shaft (604). The medium generator supporting frame (606) is mounted on one large power generator system (607) that rotates 360 degrees freely in counter clockwise and counter clock wise. The large power generator system (607) is mounted on a round supporting frame (608) firmly installed on a ground (609).

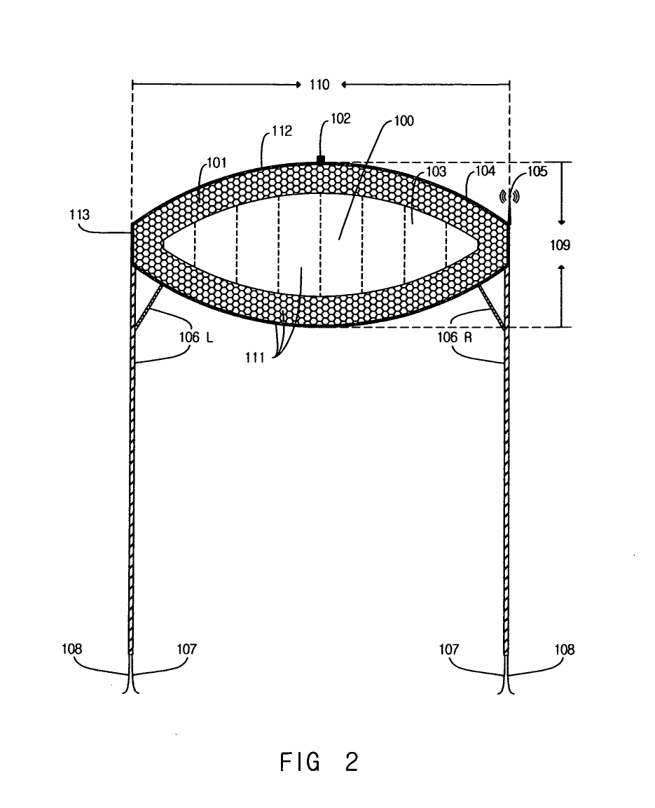

FIG. 2 is a plane view of a kite (100) according to current invention. The kite (100) of the current invention has a shape of two arcs (112) connected with two straight zones (113). The fabrics (103) used for the kite (100) of the current invention is fabrics used for Para gliders, such as Nylon®. However, the kite (100) of the current invention is equipped with Helium gas tubes (101) to enhance the buoyancy force at the initial stage of flying the kite (100) into the sky. Helium gases are introduced to the tubes (101) through the helium gas injection nozzle (102) on the ground. The helium tubes (101) are made of special composite material such as butyl rubber coated Nylon® tubes to minimize leak of the helium during the operation. Pluralities of LED lights (104) are attached to the kite (100) to send out warning sign to flying objects and preventing them collide with the kite (100), which reaches about 1.5 km height from the ground when fully stretched. GPC signal generator (105) is also attached to the kite for public safety. Width (109) of the kite (100) is 4 meter and length (110) is 10 meter. Total surface area is 35 square meter.

Each kite (100) of the current invention is conned to the cable shafts, (201) to (501), on the three dimensional power generating system (1) via two cables (106R and L), left-side and right side of the kite (100). Each cable is wound on one cable shaft in opposite direction of the wind to realize “automatic winding and rewinding” of the cables (106R) and (106L).

### Mechanism for Automatically Winding and Releasing the Kite Cables.

Before the current application, all the ‘kite driven power generators’ of the prior arts use power to wind the kites with winders. The power used for this winding step comes from the electricity generated by the kite power generator and saved in energy reservoir such as battery. The power consumption at this winding step increases as the velocity of the wind is higher. So, higher wind velocity is helpful to generate power when the kite is deployed but spend more energy when winding the kite. So, the overall energy efficiency is lowered because of the drag force when winding the kites down. One object of the current invention is to increase energy efficiency of a kite driven electricity generator by minimizing the drag force when winding down a kite from its maximum stretched position.

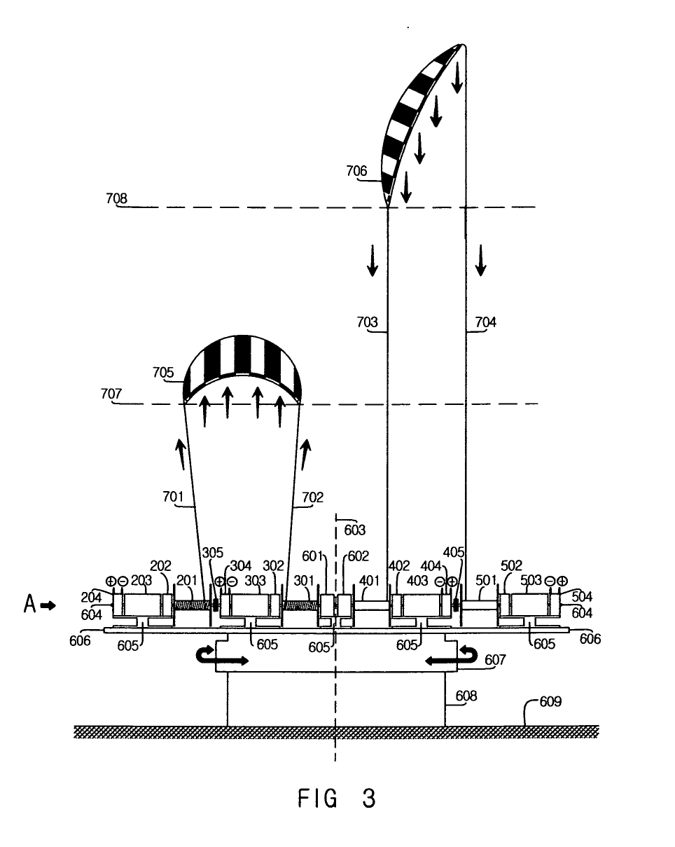

FIG. 3 is a schematic sketch of a kites (705), (706) connected to the three dimensional power generating system (1) of the current invention. Here, the left kite (705) is connected to the first cable shaft (201) and the second cable shaft (301) via the first left cable (701) and the first right cable (702). The right kite (706) is connected to the third cable shaft (401) and the fourth cable shaft (501) via the second left cable (703) and the second right cable (704)

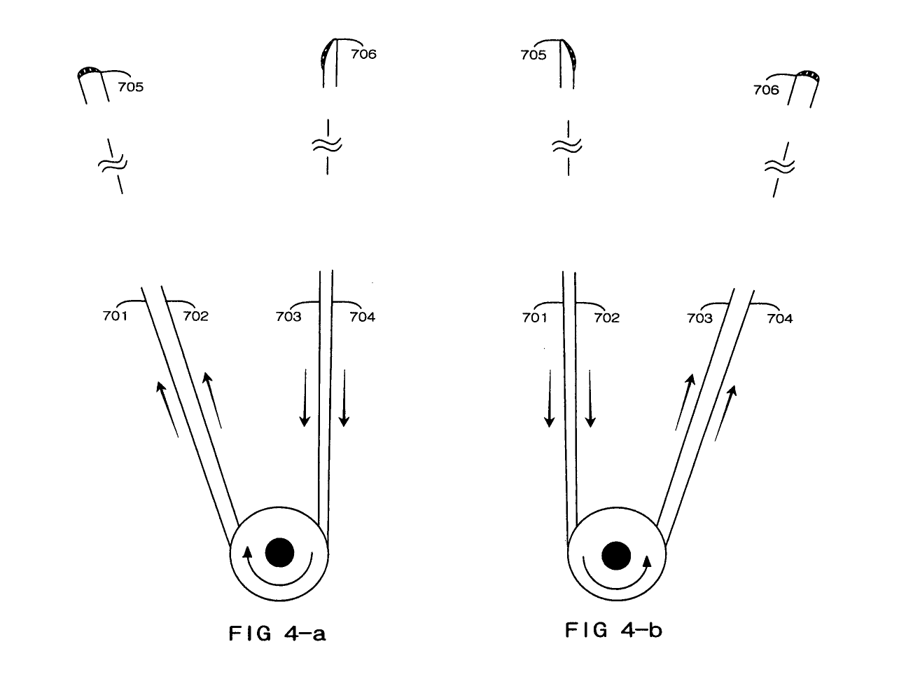

The two kites (705) and (706) repeatedly go up and down between 600 meters (707) to 1,200 meters (708) height from the ground with minimum energy loss. FIG. 4-a and FIG. 4-b are schematic side view of the ‘mechanism of automatic winding and releasing kite cables’ of the current invention from direction A in the FIG. 3. As shown in the FIG. 3 the left kite (705) is connected to the first cable shaft (201) and the second cable shaft (301) via the first left cable (701) and the first right cable (702). And the right kite (706) is connected to the third cable shaft (401) and the fourth cable shaft (501) via the second left cable (703) and the second right cable (704). The lengths of the first left cable (701) is 1,200 meter, the first right cable (702) is 1,210 meter, the second left cable (703) is 1,200 meter and the second right cable (704) right cable is 1,200 meter. The length of the left and right cables for each kite is different to minimize drag force when the kite is winded down.

When the direction of winding of the cables (701) and (702) on the first and second cable shafts of (201) and (301) is fixed as the FIG. 4-a, the direction of winding cables (703) and (704) is opposite on the third cable shaft (401) and the fourth cable shaft (501) as shown in the FIG. 4-a. So, when the left kite (705) of FIG. 3 is deploying all the cable shafts turns clock wise by the buoyancy force of the left kite (705). Since the winding cables (703) and (704) are wound as opposite direction of the cables (701) and (702) on the cable shafts (401) and (501), the cables (703) and (704) are start to winding without using any winder. Then the right kite (706) starts to descend down. When the right kite (706) start to descend, the second right cable (704) is released 10 meter further to change the right kite (706)'s position from parallel to vertical to the ground as shown in the FIG. 3. At this position, the drag force by the right kite (706) is reduced compared to the drag force when the right kite (706) is parallel to the ground.

So, no additional power is needed to wind down the kite from its fully stretched position. And since the drag force caused by the descending kite is minimum, the overall energy efficiency of the electricity generating system of the current invention is higher than previous electricity generating systems driven by kites, which spend extra electricity to wind down the kite.

The electricity generator (1) of the current invention operates as follows;

Fill the helium gas tube (101) of the kite (100) [(705) and (706)] of the current invention by injecting helium gas through the helium gas injection nozzle (102). Then hold the kites (705) and (706), of which the helium gas tubes are filled with helium gas, on the ground.

Tie the second left cable (703) and the second right cable (704) on the third cable shaft (401) and the fourth cable shaft (501) respectively. Wind the second left cable (703) and second right cable (704) up to 600 meter by rotating the third cable shaft (401) and the fourth cable shaft (501). Stop rotating the third cable shaft (401) and the fourth cable shaft (501) and hold that position. Still hold the right kite (706) on the ground.

Tie the first left cable (701) and the first right cable (702) to the first cable shaft (201) and the second cable shaft (301), respectively. And hold the left kite (705) on the ground.

Release the right kite (706) to the air freely for the first 600 meter by the buoyancy force of the helium in the helium tube (102) of the right kite (706). Once the right kite (706) reaches at the height of 600 meter, the right kite (706) goes up higher by the buoyancy force and the wind's drag force up to the maximum deployed position, 1,200 meter from the ground. During the second 600 meter climb of the right kite (706), 600 meter of the first left cable (701) and the first right cable (702) are wound, in the opposite direction of the second left cable (703) and the second right cable (704), on the first cable shaft (201) and the second cable shaft (301), respectively.

When the right kite (706) reached at the maximum deployed position of 1,200 meter, release the left kite (705) freely up to the sky by the buoyancy force of the helium gas in the helium tube (102) of the left kite (705).

At this moment, the two kites (705) and (706) are in parallel position to the ground. While the second left cable (703) is fully released. 10 meter of the second right cable (704) is left on the fourth cable shaft (501). Meanwhile, 600 meter of the first left cable (701) and 610 meter of the first right cable (702) is still wound on the first cable shaft (201) and the second cable shaft (301) respectively.

Then release the additional 10 meter of the second right cable (704) by activating the second automatic clutch (405). Then the right kite (706) changed the position vertical to the ground as shown in the FIG. 3. In this state the wind can not push the right kite (706) in that height any more and but due to the buoyancy force of the helium gas the right kite (706) does not fall suddenly. Meanwhile, the wind pushes the left kite (705) upward.

Then due to the dragging force by the wind all the cable shafts (201), (301), (401), and (501) start to turn clockwise as shown in the FIG. 4-a.

Then the four medium size electricity generators (203), (303), (403) and (503) starts to turn at a speed 97 times faster than the speed of the shafts (201) to (501) due to the four 1:97 ratio multiplying gears (202), (302), (402), and (502) and generate electricity. The generated electricity is transferred to proper electricity storages (not shown in the Figures) after pass through the four ampere transfers (204), (304), (404), and (504) that are attached to the generators (203), (303), (403) and (503), respectively.

When the left kite (705) reaches at 1,200 meter, at maximum height, the right kite (706) comes down at the height of 600 meter from the ground. Then activate the first automatic clutch (305) to release the first right cable (702) and rewind the second right cable (704) by operating the second automatic clutch (405) in rewinding position at the same time.

Then the left kite (705) will be in vertical position at 1,200 meter height and the right kite (706) will be in horizontal position at 600 meter height. At this moment the wind blow up the right kite (706) and then the left kite (705) will descend by the dragging force of the right kite (706).

Then due to the dragging force by the wind all the cable shafts (201), (301), (401), and (501) start to turn anti-clockwise as shown in the FIG. 4-b.

Then the four medium size electricity generators (203), (303), (403) and (503) starts to turn at a speed 97 times faster than the speed of the shafts (201) to (501) due to the four 1:97 ratio multiplying gears (202), (302), (402), and (502) and generate electricity. The generated electricity is transferred to proper electricity storages (not shown in the Figures) after pass through the four ampere transfers (204), (304), (404), and (504) that are attached to the generators (203), (303), (403) and (503), respectively.

As describe above, once one of the kites (705) and (706) is in the air, the three dimensional power generating system (1) of the current invention continuously generates electricity as far as the wind blows at an altitude higher than 600 meter by just operating the automatic clutches (305) and (405) in rewinding position and releasing position.

Speed of the ascending kite is controlled by the automatic break (601) and speed of the generators (203) to (503) can be controlled by the gear switching box (602).

Electricity is also generated from the large power generator system (607) when the medium generator supporting frame (606) oscillates and/or turns around of the center (603) of the three dimensional power generating system (1).

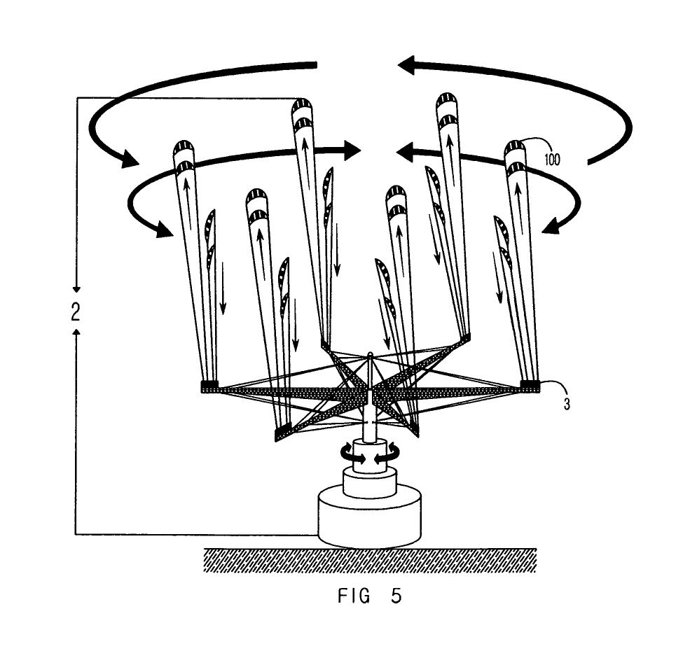

FIG. 5 is a schematic drawing of large power generator (2) that uses multi kites (100) on one pair of the cables and multi medium size power generators (3) of the current invention.

What is claimed is:

1. A medium/large electricity generator equipped with automatically winding and un-winding kite cable mechanism for less energy loss compared to other prior arts comprises of;
four medium size electricity generators,
and
two large kites, each of which is connected to the two neighboring cable shafts via two kite cables, each of which is connected to one cable shaft,
and
four multiplying gears,
and
four ampere transfers,
and
four cable shafts,
and
two automatic clutches,
and
one automatic break,
and
one auto gear transformer mounted on one medium generator supporting frame, which is mounted on one large power generator system that rotates 360 degrees freely in counter clockwise and counter clockwise.

2. A medium/large electricity generator equipped with automatically winding and un-winding kite cable mechanism for less energy loss compared to other prior arts of the claim 1, wherein the large power generator system is mounted on a round supporting frame firmly installed on the ground.

3. A medium/large electricity generator equipped with automatically winding and un-windig kite cable mechanism for less energy loss compared to other prior arts of the claim 1, wherein one of the two kite cable is 1,200 meter and the other is 1,210 meter to change the position of the kite from horizontal to the ground to vertical to the ground to minimize the drag force of the kite when re-winding the kite from its highest altitude.

4. A medium/large electricity generator equipped with automatically winding and un-winding kite cable mechanism for less energy loss compared to other prior arts of the claim 1, wherein the helium gas is filled in the helium gas tubes that are attached to the brim of the kite to render buoyancy force to the kite.

5. A medium/large electricity generator equipped with automatically winding and un-winding kite cable mechanism for less energy loss compared to other prior arts of the claim 1, one of the kite is re-winding with minimum drag force without using any winder while the other kite is deploying due to the buoyancy force of helium gas in the helium gas tube on the kite and drag force of the wind at the 600 meter altitude.
